(19) United States
(12) Patent Application Publication
(10) Pub. No.: US 2004/0023039 A1
(43) Pub. Date: Feb. 5, 2004

(54) Laminated safety glass windowpane, method for the production and use thereof

(76) Inventors: Michael Schwamb, Frankfurt (DE); Hans Weinfurtner, Wernberg-Koblitz (DE); Klaus Holtmann, Hannover (DE); Jorg Herasimtschuk, Oberurel (DE); Klaus Weitzel, Frankfurt (DE)

Correspondence Address: FULBRIGHT & JAWORSKI, LLP, 666 FIFTH AVE, NEW YORK, NY, 10103-3198, US

(21) Appl. No.: 10/380,017

(22) PCT Filed: Aug. 30, 2001
(86) PCT No.: PCT/EP01/09617

(30) Foreign Application Priority Data
Sep. 11, 2000 (DE) 100 45 006.7

(51) Int. Cl. B32B 17/06

(52) U.S. Cl. 428/441; 428/426; 428/428

(57) ABSTRACT

A composite safety glass panel with a predetermined breaking position is described, containing at least two prestressed glass panels and a polymeric intermediate layer. The polymeric intermediate layer contains two plastics materials of different fracture resistance, different elongation at break and different fracture propagation resistance. The composite glass panel contains as predetermined breaking position the plastics material having the lower fracture resistance, the lower elongation at break and the lower fracture propagation resistance, and in the region that does rot constitute the predetermined breaking position contains the plastics material having the higher fracture resistance, the higher elongation at break and the higher fracture propagation resistance. The composite glass panel also contains at at least one place (at the striking point) one or more bodies of a material whose hardness is greater than that of the glass that is used.

The present invention relates to a composite safety glass panel with a predetermined breaking position that can be used for example for an emergency exit system or emergency entry system, as well as a process for the production of a composite safety glass panel with a predetermined breaking position and the use of the composite safety glass panel with a predetermined breaking point.

Composite safety glass panels (CSG panels) with an emergency exit system are known from DE 4428690 and U.S. Pat. No. 5,350,613. Such composite safety glass panels consist of at least two panes with a polymeric intermediate layer, a predetermined breaking position being contained in the intermediate layer.

The predetermined breaking position described in DE 4428690 is formed by a local weakness in the interposed polymeric layer. This is achieved by reducing the adhesion of the layer to the glass or also between different sites in the layer. This solution has the following disadvantages:

If the adhesion of the layer to both glass panes is reduced, then if both panes are smashed a gap is produced in which, although the glass falls away from the intermediate layer, a spatial closure is still always formed by the intermediate layer. This can of course be expanded and can also fracture under a sufficiently high stress. However, a sufficiently large opening is still not formed in the panel and the function of an emergency exit is not ensured. A further non-directional fracturing of the layer is then only possible if the resistance to fracturing of the polymer intermediate layer is relatively low, this having a disadvantageous effect on its function as a composite safety glass. If a polymeric intermediate layer having a higher resistance to fracturing is used, then this may a have to be cut using an additional implement (column 3, paragraph 1). It rust be remembered however that, in a emergency, this may not be easy for a passenger who is possibly in a state of panic. Moreover, due to the non-directional fracturing of the polymeric intermediate layer an extremely small exit opening is formed that is bordered by irregular sharp edges. Serious injuries due to cuts must therefore be expected when escaping through the opening in the glass.

If the adhesion between different regions of the polymeric intermediate layer is reduced still further, then of course the effort required to produce an open gap in the glass panel is also reduced. However, such a gap is still always insufficient for it to be possible quickly to form an emergency exit opening. The problem of the unoriented fracture propagation in the polymeric intermediate layer still remains, as does the restricted resistance to fracturing of the intermediate layer.

A hammer with a sharp point provided for this purpose is therefore required in order to shatter both panes of the composite safety glass unit. In the case of a blunt striking implement the intermediate layer acts as a shock absorber and it is therefore not possible, due to the polymeric intermediate layer, to reach the surface of the second pane. Accordingly it is extremely difficult if not impossible to shatter the second glass panel using an implement other than a sharp-pointed hammer (ESG hammer).

The use of float glass in the aforedescribed composite glass panel with emergency exit system is not recommended since, when float glass shatters, sharp jagged glass shards are formed (additional danger of injury) and these jagged shards cover the predetermined breaking position and thus restrict its function.

A further disadvantage is the very low fracture resistance of the intermediate layer. Accordingly, when, part of a pane is removed that part of the pane still remaining in the frame can break off due to its own weight, and can cause further injury.

The composite glass panel with a predetermined breaking position described in U.S. Pat. No. 5,350,613 has the following disadvantages: penetration of both panels at the “strike here” point with only one blow is possible only by using an ESG hammer having a suitably long shank. Such a hammer can however be used as a weapon and is therefore classed as a security risk.

The predetermined breaking position is realized by a double-sided adhesive strip consisting of a foamed material. The high extensibility and compressibility of the foamed material may lead to difficulties in the fabrication of the panels, since, when they are filled with casting resin, the hydrostatic pressure in the region of the predetermined breaking position leads to a change in the layer thickness.

A broken panel is held together only by bridges of hardened fracture resistant casting resin existing between the pieces of foamed material. The residual load-bearing capacity of such a broken panel may be insufficient when using an insufficiently fracture-resistant intermediate layer, and may for example cause the loosened fractured glass layer to break off and fall onto persons underneath. If however an intermediate layer which is extremely resistant to fracturing is used, as would be necessary in order to achieve a high residual load-bring capacity, then there is the danger that the bridges consisting of casting resin would not fracture under stress, thereby impairing the function of the emergency exit.

The object of the present invention is to avoid the aforedescribed disadvantages of the prior art and in particular to provide a composite safety glass panel (CSG panel) in which an emergency exit opening can be produced in the panel without having to use a special implement, to enable people inside a vehicle or a building to escape through this opening in the event of an emergency, or to enable rescue services to enter the interior of a vehicle or a building without having to use a special implement. The shattered but still unopened CSG panel should have such a residual load-bearing capacity that the predetermined breaking position can he ruptured only by subjecting it to a specific stress (for example by manual pressure on the CSG panel in the immediate vicinity of the predetermined breaking point), whereupon the CSG panel can be opened. Furthermore the resistance to fracturing of the intermediate layer should be calculated so that, after the glazing unit has been tilted, the loosened part of the CSG panel does not break off along the tilting axis and fall onto and injure people.

This object is achieved by a composite safety glass panel with a predetermined breaking point; containing at least two prestressed glass panes and a polymeric intermediate layer. In this connection the polymeric intermediate layer contains two plastics materials of different resistance to fracturing (measured according to DIN 53504, 03/851 on a S2 standard test piece at a test speed of 100 mm/minute at 23° C.), different elongation at break (measured according to DIN 53504, 03/85, on a S2 standard test piece at a test speed of 100 mm/minute at 23° C.) and different fracture propagation resistance (measured according to DIN 53356, 08/82, on a 2 mm thick polymer film at a tear rate of 400 mm/minute at 23° C.). The composite glass panel contains, as predetermined breaking position, the plastics material having the lower fracture resistance, the lower elongation at break and the lower fracture propagation resistance, and in the region that does not constitute the predetermined breaking point, contains the plastics material having the higher fracture resistance, the higher elongation at break and the higher fracture propagation resistance. Furthermore the composite glass panel contains at one place or at several places a recess, preferably circular in shape. This recess (the striking point) does not contain the aforedescribed intermediate layer, but contains instead one or more bodies of a material whose hardness is greater than that of the glass that is employed. Preferably the hard bodies are embedded in a soft, plastics material. This “embedding plastics material” may be a hardened casting resin with appropriate properties and/or a polymeric film, for example of polyisobutylene.

As glass panes there maybe used flat glass sheets from the group consisting of alkali-lime glasses, such as soda-lime glass (e.g. according to DIN EN 572, 1-7), or borosilicate glasses. The glass panes are prestressed or partially prestressed. The prestressing or partial prestressing may be carried out thermally (according to DIN EN 12150, 96/2 and/or DIN EN 1863/1 2000/3 and/or DIN EN 13024/1 98/1) or chemically. The glass panes preferably have a thickness of 0.1 to 12 mm and particularly preferably a thickness of 0.5 to 6 mm. The optimal thickness is 1 to 4 mm.

In an emergency both glass panes can be shattered with a blow on the striking point using a blunt object, e.g. a rubber hammer. This is achieved if the body or bodies located at the striking point in the CSG panel interspace is of a material whose hardness is greater than that of the glass. Preferably the bodies have a Mohs' hardness of >6, particularly preferably of >7. The hard bodies preferably consist of granules or spheres. Particularly preferably the bodies consist of granules, which ideally have sharp edges. Bodies of silicon carbide or corundum may for example be used. In this case the hard bodies are rigidly mounted by means of a soft, plastics material (such as for example polyisobutylene, also called butyl) between the two outerlying glass panes in the space provided for this purpose. Preferably the size of the bodies is chosen to be 0.1 to 0.3 mm, particularly preferably 0.1 mm less than the thickness of the casting resin layer. If a high pressure is now built up in a pulse-type manner in the region of the striking point, e.g. by striking the point with a blunt object, then the hard bodies are forced with a sufficiently high pressure against both pane surfaces due to the local flexing of the panel in the region of the hammer blow. A crack in the glass thus forms perpendicular to the glass surface underneath the penetrating body or bodies. When the tip of the crack reaches the tensile stress zone of the prestressed glass, the whole panel shatters in a known manner.

The emergency exit opening can now be made at the predetermined breaking point. In order to create an opening in the region of the predetermined breaking point, an incipient crack is necessary that propagates as a linear continuing crack in the direction of the longitudinal alignment of the predetermined breaking point. Only by applying a force in the vicinity of the predetermined breaking position (for example by simple hand pressure) and exceeding the fracture propagation resistance of the predetermined breaking position material is it possible to cause the crack to propagate and thereby produce an emergency exit opening.

By using two plastics materials having in each case different fracture mechanical properties and by means of the predetermined breaking position produced in this way, a higher residual load-bearing capacity of the shattered CSG panel is achieved than with a known CSG panel, in which the predetermined breaking position is formed by reducing the adhesion between the intermediate layer and glass or between different regions of the intermediate layer. The residual load-bearing capacity of a shattered CSG panel is the ability to withstand a defined load for a specific time without forming an opening. In this connection there are several possible ways of forming the predetermined breaking point. Thus, for example, the predetermined breaking position may be formed by a casting resin that is preferably transparent, or the predetermined breaking position may be formed for example by a thermoplastic material that is permanently flexible at room temperature. The predetermined breaking position may also be designed so that the polymeric intermediate layer not forming the predetermined breaking position is not interrupted everywhere (the plastics material forming the predetermined breaking position is located in the discontinuity), but is simply interrupted section-wise, the plastics material forming the predetermined breaking position being located in the discontinuities.

By varying and specifically adjusting the fracture mechanical properties of the two different plastics materials (plastics material for the region that does not form the predetermined breaking point, and plastics material for the predetermined breaking point) the necessary residual load-bearing capacity of the shattered but still unopened panel can be adjusted over a very wide variation range.

Preferably the plastics material from which the predetermined breaking position is fabricated has, compared to the plastics material not forming the predetermined breaking point, apart from the lower fracture resistance, the lower elongation at break and lower fracture propagation resistance, also a lower hardness and is preferably permanently flexible at room temperature.

The following values may be given by way of example for the fracture mechanical properties and hardness of the plastics material of the predetermined breaking position (the values being based on the aforementioned DIN and the Shore A hardness being determined according to DIN 53505 on 6 mm thick test pieces at 23° C.).:

| | | |
|---|---|---|
| Fracture | 0.01 to 2 MPa, | pref. 0.1 to 1.5 MPa; |
| resistance | | |
| Elongation at break | 10 to 450%, | pref. 10 to 150%; |
| 25% modulus | maximum 0.2 MPa; | |
| 50% modulus | maximum 0.3 MPa; | |
| 100% modulus | maximum 0.4 MPa; | |
| Fracture propa- | maximum 3 N/mm, | pref. max. 2 N/mm; |
| gation resistance | 1 to 40, | pref. 5 to 30. |
| Shore A hardness | | |

The following values may be given by way of example for the fracture mechanical properties and hardness of the plastics material that does not form the predetermined breaking point:

| | | |
|---|---|---|
| Fracture | at least 4 MPa, | pref. min. 10 MPa; |
| resistance | | |
| Elongation at break | at least 200%, | pref. min. 300%; |
| Fracture propa- | at least 6 N/mm, | pref. min. 15 N/mm; |
| gation resistance | | |
| Shore A hardness | 30 to 70, | pref. 40 to 60. |

The plastics material used to produce the predetermined breaking position may contain a casting resin or may consist of a casting resin. This casting resin may be formed from a linear, non-crosslinked or partially crosslinked polymer. The polymer may be based on polyurethane, polyepoxide, polyester, polysiloxane and/or polyacrylate. Preferably a casting resin based on polyacrylate is employed. The polyacrylate consists principally of reactive acrylate and methacrylate monomers that fox a copolymer on hardening. The casting resin used for the production of the predetermined breaking position also contains initiators and may moreover contain unreactive acrylate and methacrylate homopolymers and copolymers, fillers, plasticisers, tackifying additives and stabilisers.

Alternatively the plastics material for the production of the predetermined breaking position may contain a thermoplastic material which is permanently flexible at room temperature, or may consist of such a material. This material may be formed from a non-crosslinked or partially crosslinked polymer. The polymer may be based for example on homopolymers, copolymers or terpolymers of isobutylene or mixtures thereof, and may also be formed from copolymers of acrylates or methacrylates or mixtures thereof (base polymer).

Further constituents of the thermoplastics material way include thermoplastic polymers, natural and synthetic rubbers, tackifying additives, plasticisers, bonding agents, reinforcing and non-reinforcing fillers, stabilisers and other additives.

Homopolymers of isobutylene are polyisobutylenes that are commercially available in various molecular weight ranges. Examples of polyisobutylene trade names are Oppanol (BASF AG), Vistanex (Exxon), or Efrolen (Efremov). The state of the polyisobutylenes ranges from liquid through soft resinous to rubber-like. The molecular weight ranges may be specified as follows: the number average molecular weight is 2,000 to 1,000,000 g/mole, preferably 24,000 to 600,000 g/mole, and the viscosity mean value of the molecular weight is 5,000 to is 6,000,000 g/mole, preferably 40,000 to 4,000,000 g/mole.

Copolymers and terpolymers of isobutylene contain, as comonomers and termonomers, 1,3-dienes such as isoprene, butadiene, chloroprene or β-pinene, functional vinyl compounds such as styrene, α-methylstyrene, p-methylstyrene or divinylbenzene, or further monomers. An example of a copolymer of isobutylene and isoprene is butyl rubber with minor proportions of isoprene; various butyl types are for example commercially available from Bayer AG, Exxon Chemical or Kautschuk-Gesellschaft. Terpolymers of isobutylene with the monomers isoprene and divinylbenzene produce partially crosslinked types of butyl rubber, which can also be obtained by subsequent crosslinking of butyl rubber; commercially available types are for example LC Butyl from Eon Chemical, Kalar from Hardman or Polysar Butyl XL from Bayer AG. The homopolymers, copolymers and terpolymers of isobutylene may also be subjected to a subsequent chemical modification; the conversion of butyl rubber with halogens (chlorine, bromine) leading to chlorinated butyl rubber and brominated butyl rubber is known. The conversion of a copolymer of isobutylene and p-methylstyrene with bromine to form a terpolymer of isobutylene, p-methylstyrene and p-bromomethylstyrene is carried out in a similar way, and the resultant product is commercially available under the trade name EXXPRO from Exxon Chemical.

Homopolymers or copolymers of acrylates on methacrylates (poly (meth) acrylates) are polymers of acrylic and/or methacrylic acid esters, and may include for example as alcohol component an alkyl group substituted with functional groups or an unsubstituted alkyl group, for example methyl, ethyl, propyl, iso-propyl, n-butyl, isobutyl, tert.-butyl, pentyl and hexyl and their isomers and higher homologies, 2-ethylhexyl, phenoxyethyl, hydroxyethyl, 2-hydroxypropyl, caprolactonehydroxyethyl, or dimethylamincethyl. Also included are polymers of acrylic acid, methacrylic acid, amides of the aforementioned acids, and acrylonitrile polymers, Partially crosslinked poly(meth)acrylates in which the crosslinking is effected via a multifunctional monomer with for example diethylene glycol or trimethylolpropane as alcohol component, as well as mixtures of the polyacrylates and polymethacrylates, may also be used.

Examples of thermoplastic polymers are polyolefins as homopolymers and copolymers, built up from the monomers ethylene, propylene, n-butene and their higher homologues and isomers, and from functional vinyl compounds such as vinyl acetate, vinyl chloride, styrene and α-methylstyrene. Further examples are polyamides, polyimides, polyacetals, polycarbonates, polyesters and polyurethanes, and mixtures of the aforementioned polymers.

Natural and synthetic rubbers may be selected from the group comprising homopolymers of dienes, the group comprising copolymers and terpolymers of dienes with olefins, and the group consisting of copolymers of olefins. Examples are polybutadiene, polyisoprene, polychloroprene, styrene-butadiene rubber, block copolymers with blocks of styrene and butadiene or isoprene, ethylene-vinyl acetate rubber, ethylene-propylene rubber and ethylene-propyline-diene rubber, for example with dicyclopentadiene or ethylidene norbornene as diene component. The rubbers may also be employed in hydrogenated form and also as mixtures.

Tackifying additives may be selected from the group consisting of natural and synthetic resins and also subsequently modified resins that include, inter alia, hydrocarbon resins, colophony and its derivatives, polyterpenes and their derivatives, coumarone-indene resins and phenol resins, and from the group comprising polybutenes, polyisobutenes and degraded liquid rubbers (e.g. butyl rubber or EPDM), which may also he hydrogenated. Mixtures of the aforementioned tackifying additives may also be used.

Examples of plasticisers include esters of phthalic acid (e.g. di-2-ethylhexyl, diisodecyl, diisobutyl or dicyclohexyl phthalate), of phosphoric acid (e.g. 2-ethylhexyldiphenyl, tri-(2-ethylhexyl) or tricresyl phosphate), of trimellitic acid (e.g. tri-(2-ethylhexyl) or triisononyl trimellitate), of citric acid (e.g. acetyltributyl or acetyltriethyl citrate) or of dicarboxylic acids (e.g. di-2-ethylhexyl adipate or dibutyl sebacate). Mixtures of the plasticisers may also be used.

Bonding agents may be selected from the group consisting of silanes, which may include for example 3-glycidyloxypropyl trialkoxysilane, 3-aminopropyl trialkoxysilane, N-aminoethyl-3-aminopropyl trialkoxysilane, 3-methacryloxypropyl trialkoxysilane, vinyl trialkoxysilane, iso-butyl trialkoxysilane, 3-mercaptopropyl trialkoxysilane, from the group comprising silicic acid esters, e.g. tetraalkyl orthosilicates, aid from the group comprising metallates, e.g. tetraalkyl titanates or tetraalkyl zirconates, as well as mixtures of the aforementioned bonding agents.

Stabilisers may be antioxidants of the sterically bindered phenols type (e.g. tetrakis [methylene-3-(3,5-di-tert.-butyl-4-hydroxyphenyl)-propionate]methane) or of the sulfur-based antioxidants type such as mercaptans, sulfides, polysulfides, thiourea, mercaptals, thioaldehydes, thioketones, etc., or UV protection agents of the benzotriazoles type, benzophenones type or the BALS (hindered amine light stabilizer) type or ozone protective agents. These may be used alone or in the form of mixtures.

Examples of reinforcing Sad non-reinforcing fillers are pyrogenic or precipitated silicic acid, silica gel, precipitated or ground chalk (also surface-treated), calcium oxide, clay, kaolin, talc, quartz, zeolites, titanium dioxide, glass fibres or aluminium powder and zinc powder and mixtures thereof.

If a dark colour of the plastics material forming the predetermined breaking position is not considered unacceptable, then carbon black, carbon fibres or graphite may also be employed.

The plastics material used to product the polymeric intermediate layer that does not form the predetermined breaking position may contain a thermoplastics adhesive film or may consist of the latter. The adhesive film may contain polyvinyl acetals or polyurethanes.

The plastics material for the production of the polymeric intermediate layer that does not form the predetermined breaking position may also contain a casting resin or may consist of a casting resin. This casting resin may be formed from a crosslinked or partially crosslinked polymer. The polymer may be based on polyurethane, polyepoxide, polyester, polysiloxane and/or polyacrylate. The casting resin used is preferably based on polyacrylate. The polyacrylate consists principally of reactive acrylate and methacrylate monomers. The casting resin used to produce the polymeric intermediate layer furthermore contains acrylate-functional and methacrylate-functional oligomers such as for example urethane acrylates, polyester acrylates, as well as bonding agents and initiators. In addition unreactive acrylate and methacrylate homopolymers and copolymers, fillers, plasticisers, tackifying additives and stabilisers may also be included.

The following qualitative description of the casting resin constituents applies to a casting resin that does not form the predetermined breaking point, as well as to a casting resin that forms the predetermined breaking point.

As reactive acrylate and methacrylate monomers there are used monofunctional and polyfunctional, preferably monofunctional esters of acrylic acid and/or methacrylic acid. The employed alcohol components of the esters may contain an unsubstituted alkyl group or an alkyl group substituted with functional groups, such as methyl, ethyl, propyl, iso-propyl, n-butyl, tert.-butyl, pentyl, hexyl, their isomers and higher homologues such as 2-ethylhexyl, phenoxyethyl, hydroxyethyl, 2-hydroxypropyl, caprolactonehydroxyethyl, polyethylene glycols with a degree of polymerisation of 5 to 20, polypropylene glycols with a degree of polymerisation of 5 to 20, and dimethylaminoethyl. As reactive monomers there may also be used acrylic acid and methacrylic acid themselves, the amides of these acids, and acrylonitrile. Mixtures of the reactive acrylate and methacrylate monomers may also be used.

Examples of acrylate-functional and methacrylate-functional oligomers are epoxy acrylates, urethane acrylates, polyester acrylates and silicone acrylates. The oligomers may be monofunctional or higher functional, difunctional oligomers preferably being employed. Mixtures of the oligomers may also be used.

Epoxy acrylates are based on bisphenol A diglycidyl ethers or bisphenol F diglycidyl ethers terminated in each case with acrylic or methacrylic acid, their oligomers, or novolak glycidyl ethers.

Urethane acrylates are built up from isocyanates (e.g. toluylene, tetramethylxylene, hexamethylene, isophorone, cyclohexylmethane, trimethylhexamethyl, xylene or diphenylmethane diisocyanates) and polyols, and functionalised with hydroxyacrylates (e.g. hydroxyethyl acrylate) or hydroxymethacrylates (e.g. hydroxyethyl methacrylate).

The polyols may be polyester polyols or polyether polyols. Polyester polyols may be produced from a dicarboxylic acid (e.g. adipic acid, phthalic acid or their anhydrides) and a diol (e.g. 1,6-hexanediol, 1,2-propanediol, neopentyl glycol, 1,2,3-propanetriol, trimethylolpropane, pentaerythritol or ethylene glycols such as diethylene glycol). Polyester polyols may also be obtained by reacting a hydroxycarboxylic acid (e.g. starting from caprolactone) with itself. Polyether polyols may be produced from ethylene oxide or propylene oxide.

Polyester acrylates are the aforedescribed polyester polyols that have been functionalised with acrylic acid or with methacrylic acid.

The silicone acrylates known pr se and used here are based on polydimethylsiloxanes of different molecular weights functionalised with acrylate.

Unreactive acrylate and methacrylate homopolymers and copolymers are homopolymers and copolymers of acrylic acid, methacrylic acid and the aforedescribed esters of is these acids. The bonding agent may also contain mixtures of the aforementioned homopolymers and copolymers. The casting resin may also be produced from unreactive acrylate or methacrylate homopolymers and copolymers.

Photoinitiators may be used as initiators. These may be selected from the group consisting of benzoin ether, benzyl ketals, α-dialkoxyacetophenones, α-hydroxyalkylphenones, α-aminoalkylphenones, acylphosphine oxides, benzophenones or thioxanthones or mixtures thereof. The task of the initiators is to initiate the hardening of the casting resin.

Bonding agents may be selected from the group consisting of organofunctional silanes, such as 3-glycidyloxypropyl trialkoxysilane, 3-aminopropyl trialkoxysilane, N-aminoethyl-3-aminopropyl trialkoxysilane, 3-methacryloxypropyl trialkoxysilane, vinyl trialkoxysilane, iso-butyl trialkoxysilane, mercaptopropyl trialkoxysilane, and from the group consisting of silicic acid esters such as tetraalkyl orthosilicate. The respective casting resin may also contain mixtures of the aforementioned bonding agents.

Fillers may be reinforcing or non-reinforcing. As fillers there may be used pyrogenic or precipitated silicic acid, which are preferably hydrophilic or have been surface treated, and cellulose derivatives such as cellulose acetate, cellulose acetobutyrate, cellulose acetopropionate, methylcellulose and hydroxypropylmethyl cellulose. The respective casting resin may also contain mixtures of the aforementioned fillers.

Examples of plasticiser are esters of phthalic acid such as di-2-ethylhexyl, diisodecyl, diisobutyl, dicyclohexyl and dimethyl phthalate, esters of phosphoric acid such as 2-ethylhexyldiphenyl, tri (2-ethylhexyl) and tricresyl phosphate, esters of trimellitic acid such as tri(2-ethylhexyl) and triisononyl trimellitate, esters of citric acid such as acetyltributyl and acetyltriethyl citrate, and esters of dicarboxylic acids such as di-2-ethylhexyl adipate and dibutyl sebacate. The respective casting resin may also contain mixtures of the aforementioned plasticisers.

Tackifying additives may be selected from the group consisting of natural and synthetic, as well as subsequently modified resins. Suitable resins include hydrocarbon resins, colophony and its derivatives, polyterpenes and their derivatives, coumarone-indene resins, phenol resins, polybutenes, hydrogenated polybutenes, polyisobutenes and hydrogenated polyisobutenes. The respective casting resin may also contain mixtures of the aforementioned tackifying additives.

Stabilisers may be antioxidants such as phenols (e.g. 4-methoxyphenyl) or sterically hindered phenols (e.g. 2,6-di-tert.-butyl-4-methylphenol) or mixtures of various antioxidants.

The casting resins are produced by mixing the aforementioned components in a conventional mixing unit.

If the predetermined breaking position is formed by a casting resin, then preferred amounts of the substances to be used for the casting resin are given hereinafter (numerical data in wt. %):

| | | |
|---|---|---|
| a) | reactive acrylate or methacrylate monomers | 50-99 |
| b) | acrylate-functional or methacrylate-functional | 0-5 |
| | oligomers | |
| c) | unreactive acrylate or methacrylate | 0-5 |
| | homopolymers and copolymers | |
| d) | initiators | 0.1-2 |
| e) | bonding agents | 0-3 |
| f) | fillers | 0-10 |
| g) | plasticisers | 0-40 |
| h) | tackifying additives | 0-5 |
| i) | stabilisers | 0-2 |

Particularly preferred amounts of the substances used for the casting resin of the predetermined breaking position are;

| | | |
|---|---|---|
| a) | reactive acrylate or methacrylate monomers | 70-90 |
| b) | acrylate-functional or methacrylate- | 0-5 |
| | functional oligomers | |
| c) | unreactive acrylate or methacrylate | 0-5 |
| | homopolymers and coplymers | |
| d) | initiators | 0.1-1 |
| e) | bonding agents | 0-3 |
| f) | fillers | 0-10 |
| g) | plasticisers | 10-20 |
| h) | tackifying additives | 0-5 |
| i) | stabilisers | 0-2 |

If the predetermined breaking position is formed by a thermoplastic material that is permanently flexible at room temperature, the preferred amounts of the substances that are used are specified hereinafter (numerical data in wt. %)

| | | |
|---|---|---|
| a) | base polymer | 30-100 |
| b) | thermoplastic polymers | 0-50 |
| c) | natural and synthetic rubbers | 0-50 |
| d) | tackifying additives | 0-30 |
| e) | plasticisers | 0-50 |
| f) | bonding agents | 0-5 |
| g) | stabilisers | 0-5 |
| h) | reinforcing and non-reinforcing fillers | 0-70 |

Particularly preferred amounts are given hereinafter:

| | | |
|---|---|---|
| a) | base polymer | 40-100 |
| b) | thermoplastic polymers | 0-30 |
| c) | natural and synthetic rubbers | 0-30 |
| d) | tackifying additives | 0-25 |
| e) | plasticisers | 0-30 |
| f) | bonding agents | 0-3 |
| g) | stabilisers | 0-3 |
| h) | reinforcing and non-reinforcing fillers | 0-60 |

Preferred amounts of the substances used for the casting resin of the intermediate layer not forming the predetermined breaking position are given hereinafter:

| | | |
|---|---|---|
| a) | reactive acrylate or methacrylate monomers | 40-89 |
| b) | acrylate-functional or methacrylate- | 10-50 |
| | functional oligomers | |
| c) | unreactive acrylate or methacrylate | 0-10 |
| | homopolymers and copolymers | |
| d) | initiators | 0.1-2 |
| e) | bonding agents | 0.5-3 |
| f) | fillers | 0-5 |
| g) | plasticisers | 0-10 |
| h) | tackifying additives | 0-5 |
| i) | stabilisers | 0-2 |

Particularly preferred amounts of the substances used for the casting resin of the intermediate layer not forming the predetermined breaking position are;

| | | |
|---|---|---|
| a) | reactive acrylate or methacrylate monomers | 60-80 |
| b) | acrylate-functional or methacrylate- | 20-40 |
| | functional oligomers | |
| c) | unreactive acrylate or methacrylate | 0-5 |
| | homopolymers and copolymers | |
| d) | initiators | 0.1-1 |
| e) | bonding agents | 0.5-2 |
| f) | fillers | 0-5 |
| g) | plasticisers | 0-10 |
| h) | tackifying additives | 0-5 |
| i) | stabilisers | 0-2 |

The properties of the casting resins are governed depending on the choice of the substances employed and the amounts in which they are used. The fracture mechanical properties of the predetermined breaking position and polymeric intermediate layer are adjusted to the ranges given above by altering the proportion of the rigidifying comonomers or the crosslinking density. Every combination of the starting substances according to the aforementioned preferred quantitative amounts does not automatically lead to the desired properties of the casting resins. Formulations for the production of the casting resins are given in the examples of implementation. In order to elaborate further formulations preliminary experiments should if necessary be carried out, having regard to the following considerations.

With increasing content of rigidifying comonomers the fracture resistance, elongation at break and fracture propagation resistance rise in the specified hardness range. In order to adjust these properties, acrylic acid is preferably used as comonomer. Also, these properties may be adjusted in the specified hardness range via crosslinking with the aid of acrylate-functional and methacrylate-functional oligomers. The fracture resistance, elongation at break and fracture propagation resistance all rise with increasing functionality and decreasing mean molecular weight distribution of the acrylate-functional and methacrylate-functional oligomers and increasing content of these substances in the casting resin.

Preferably the casting resin used to produce the predetermined breaking position as well as the casting resin used to produce the polymeric intermediate layer are colourless and transparent in the hardened state.

A process for the production of a composite safety glass panel with a predetermined breaking position is described hereinafter by way of example;

If the predetermined breaking position is to be formed by a casting resin, a film is produced in a preparatory process step from the casting resin that subsequently forms the predetermined breaking point. For this purpose two 4 mm thick float glass plates are coated, with the aid of a few drops of water as adhesion agent, with a ca. 100 μm thick auxiliary film, e.g. a polyester film. The purpose of this auxiliary film is to ensure that the casting resin does not adhere to the glass plates. The film-that is chosen should be such that the hardened casting resin (the subsequent predetermined breaking point) does not adhere to it. An edge seal is applied directly in the edge region to the first of the two glass plates coated with the auxiliary film. A double-sided adhesive strip from for example the 3M company (type 4915 or 4918) or also a Naftotherm butyl cord with a core of for example polypropylene from Chemetall GmbH (type 3.215 or 3220) may be used for this purpose. After application of the edge seal, which contains a ca. 50 mm wide filling opening for the casting resin, the second glass plate coated with the auxiliary film is placed flush on the first glass plate. The two glass plates are then pressed together with the aid of jaw clamps so as to form a sealed space ca. 1.5 to 2.0 mm thick depending on the edge seal that is used. The casting resin is hen poured in, the filling opening being closed after tipping and expelling the air from the glass plate intermediate space, following which the casting resin is cured within 20 minutes by irradiating the horizontally lying sandwich arrangement with a UV lamp (e.g. from Torgauer Machinenbau with a Philips type TLD 08 blacklight blue tube). After the curing the two glass plates are separated from the auxiliary films, and the casting resin (the subsequent predetermined breaking point) that has hardened to a film is removed and cut up for example with guillotine shears into strips ca. 10 mm wide and of length determined by the geometry of the CSG panel that is subsequently to be produced.

In order to produce the CSG panel according to the invention a first prestressed glass plate is cleaned in a known manner. An edge seal (including a gap for the filling opening) is then applied to the glass plate. As edge seal there may be used a thermoplastically applicable material based on polyisobutylene from Chemetall GmbH (type Naftotherm TPS) or a Naftotherm-butyl cord from Chemetall GmbH (type 3215 or 3220), or a double-sided adhesive strip from the 3M company (type 4915 or 4918).

If the predetermined breaking position is formed by a casting resin, the hardened casting resin strips described above for the predetermined breaking points are now laid on the glass plate at the designated predetermined breaking point. Due to their intrinsic tackiness the casting resin strips adhere to the glass plate.

If the predetermined breaking position is formed by a thermoplastics material, this can be applied to the glass plate with the aid of a heated cartridge gun or with the aid of a robot and a corresponding processing unit, obtainable for example from Lenhardt Maschinenbau. The predetermined breaking position may also be applied to the glass plate in the form of a round cord of appropriate thickness previously fabricated from this plastics material.

Preferably the predetermined breaking position is in the shape of three sides of a rectangle that is situated within the area of the glass plate. The hard body or bodies is/are furthermore positioned at the desired striking point. This is preferably effected by embedding them in polyisobutylene, described in more detail hereinbelow. The second prestressed glass plate is then placed flush on the first plate. The glass plates are pressed together in a known manner. A sealed space is thus formed into which the casting resins which forms the polymeric intermediate layer outside the predetermined breaking point, is poured in a bubble-free manner. For this purpose the sandwich arrangement is preferably inclined at an angle of ca. 30° during the addition of the casting resin, and the filling can be performed from below or from above using a filling nozzle. In order to remove the air from the space between the glass plates, the sandwich arrangement is placed horizontally and the filling opening is closed in a known manner using for example Hotmelt from Chemetall GmbH (type 21 hot-melt adhesive), or with the edge sealing material itself. The sandwich arrangement is then placed under a UV lamp (for example from Torgauer Maschinenbau with a blacklight-blue tube) and the casting resin is cured within 20 minutes.

Instead of the casting resin, a polymeric transparent film, for example of polyvinyl butyral, conventionally used for the production of composite glass may also be used for the polymeric intermediate layer outside the predetermined breaking point. For this purpose the regions in which the predetermined breaking position is to be located are cut out from the foil and the aforedescribed hardened casting resin strips for the predetermined breaking position are inserted in these regions.

The resultant CSG panel with emergency exit system can be processed further as an individual CSG panel. The resultant CSG panel with predetermined breaking position can also be processed further into conventional multilayer insulating glass, wherein one or more panes of the multilayer insulating glass may consist of the CSG panel with predetermined breaking position according to the invention.

The CSG panel according to the invention may be used in buildings as well as in rail vehicles, road vehicles and marine vehicles.

The embedding of the hard bodies in polyisobutylene (for use as a striking point) may be accomplished as follows:

A thin film is fabricated from a butyl sealant (sealant containing a homopolymer, copolymer or terpolymer of isobutylene or mixtures thereof, or a copolymer of acrylates or methacrylates or mixtures thereof, optionally together with other conventional additives, e.g. Naftotherm TPS from Chemetall GmbE) The fabrication may he carried out in a platen press by compressing a cube of sealant of ca. 10 mm edge length to a thickness of 0.8 mm. This is preferably performed using two metal compression plates and a 0.8 mm thick metal spacer. Round film parts, so-called pads (diameter ca. 30 mm), are stamped out from the film produced as described above. One or more hard bodies, e.g. SiC grains, are then placed in the middle of a horizontally arranged pad. In tests, a number of 10 to 30 Sic granules have proved extremely effective. As SiC granules there may be used for example SiC granules from ESK-SIC GmbH, F14 quality. (170 mm 20 %, 1.40 mm 45%, 1.18 mm 70%) or F16 quality (1.40 mm 20 %, 1.18 mm 45%, 1.00 mm 70%).

It is recommended that the granules be screened in order to exclude granule sizes that are above the maximum granule size (this is governed by the interspacing of the two glass plates). A second pad is then placed flush on the first pad over the hard bodies. This arrangement is compressed between two metal plates to a thickness of ca. 1.6 mm. The polyisobutylene-embedded bodies of diameter Ca. 30 mm that can be used as the striking point are then punched out from this pressed article. On account of the intrinsic tackiness of the butyl sealant, handling is preferably carried out with the help of silicone paper.

The production of the casting resin for the predetermined breaking position and for the polymeric intermediate layer not forming the predetermined breaking point, the production of a thermoplastics material constituting the predetermined breaking position and that is permanently flexile at room temperature, as well as the determination of the properties of the casting resins are described in more detail in the following exemplifying embodiments (unless otherwise mentioned, % data refer to wt. %).

### EXAMPLE 1

### Production of a Casting Resin for the Predetermined Breaking Point

750 g (50%) of n-butyl acrylate and 745.5 g (49.7%) of polypropylene glycol monoacrylate (Bisomer PPA6 from International Speciality Chemicals) as reactive acrylate and methacrylate monomers were homogenised over a period of 10 minutes with the aid of a magnetic stirring rod and magnetic stirring motor, in a 2000 ml capacity polyethylene wide-necked flask 4.5 g (0.3%) of 1-hydroxycyclohexylphenyl ketone (Irgacure 184 from Ciba-Geigy) were then added as photoinitiator and dissolved within 10 minutes under intensive stirring (magnetic stirrer).

### EXAMPLE 2

### Production of a Casting Resin for the Polymeric Intermediate Layer not Forming the Predetermined Breaking Point

888 g (59.2%) of 2-ethylhexyl acrylate, 75 g (5%) of methyl methacrylate and 180 g (12%) of acrylic acid as reactive acrylate and methacrylate monomers, and 22.5 g (1.5%) of 3-glycidyloxypropyl trimethoxysilane (Dynasilan GLYM from Sivento) as bonding agent were placed in a 2000 ml capacity beaker and mixed over a period of 5 minutes with a propeller stirrer. 330 g (22%) of an aliphatic urethane acrylate (Craynor CN 965 from cray valley), which had been heated to ca 60° C. before the addition, were then mixed in as acrylate-functional oligomer within 15 minutes. Finally 4.5 g (0.3%) of 1-hydroxycyclohexylphenyl ketone (Irgacure 184 from Ciba-Geigy) were added as photoinitiator and the resultant mixture was homogenised for 10 minutes.

### EXAMPLE 3

### Production of a Round Cord of Thermoplastically Appliable, Permanently Flexible Material Bed on Polyisobutylene for use as Predetermined Breaking Point

500 g of a commercially obtainable edge sealant material based on polyisobutylene (Naftotherm. BU-TPS from Chemetall GmbH) were extruded in a laboratory extruder (G\overline{o}ttfert) at, ca. 130° C. through a 4.5 mm round nozzle to form a round cord of ca. 4.8 mm diameter. The difference in thickness between the nozzle and cord is due to expansion of the strand during extrusion. The round cord produced in this way was coiled between silicone paper and stored dry until used,

Test bodies for the measurement of the fracture mechanical properties (see Example 4) were produced by appropriate compression of Naftotherm BTU-TPS.

### EXAMPLE 4

### Comparison of the Fracture Mechanical Properties and Hardness of the Predetermined Breaking Position and Polymeric Intermediate Layer

In order to determined the properties, the casting resins from Example 1 and Example 2 were poured between two polyester supporting films and hardened so as to form a ca. 2 mm thick film. The supporting films were then removed from the respectively hardened casting resin (now present as polymer films) and the mechanical properties of the films were determined. The mechanical properties of the thermoplastic test bodies from Example 3 were also determined.

| | Predtd. | Intermediate. | Predtd. |
|---|---|---|---|
| | Breaking Point | Layer | Breaking Point |
| | (Example 1) | (Example 2) | (Example 3) |
| Shore A Hardness [1] | 25 | 48 | 10 |
| Fracture resistances | 0.17 | 9 | 0.02 |
| [MPa] | | | |
| 25% Modulus [MPa] | — | 0.4 | 0.12 |
| 50% Modulus [MPa] | — | 0.6 | 0.11 |
| 100% Modulus [MPa] | — | 0.8 | 0.08 |
| Eongation at break [%] | 20 | 350 | 360 |
| Fracture propagation | 0.2 | 12 | 0.01 |
| resistance [N/mm] | | | |

The determination of the Shore A hardness was carried out according to DIN 53505 on 6 mm thick test bodies at 23° C. The determination of the fracture resistance was carried out according to DIN S53504, 03/85, measured on an S2 standard test piece with a test speed of 100 mm/minute at 23° C. The determination of the elongation at break was carried out according to DIN 53504, 03/85, measured on an S2 standard test piece with a test speed of 100 mm/minute at 23° C. The determination of the fracture propagation resistance was carried out according to DIN 53356, 08/82, measured on a 2 mm film thick polymer film at-a tear rate of 400 mm/minute at 23° C.

### EXAMPLE 5

### Comparison of the Colour of the Predetermined Breaking Position and Polymeric Intermediate Layer

The colour was measured with a Perkin Elmer, Lambda 12 type spectrophotometer. First of all the transmission spectrum was recorded with the UV-WINLAB program and the colour evaluation was carried out by the tristimulus method using the PECOL software from CIELAB.

Evaluations with the standard illuminant DGS were made by a normal observer at 10° C. A composite consisting of 4 mm float glass/2 mm hardened casting resin/4 mm float glass was measured. A casting resin according to Example 1 was used as predetermined breaking point, and a casting resin according to ample 2 was used for the polymeric intermediate layer not forming the predetermined breaking point. No measurement samples were placed in the reference beam; i.e. the reference substance was air. The following values were found:

| | Predetermined | Polymeric |
|---|---|---|
| | Breaking position | Intermediate Layer |
| L* | 95.22 | 95.30 |
| a* | −1.85 | −1.89 |
| b* | 0.30 | 0.43 |

The measurement values show that the predetermined breaking position and the polymeric intermediate layer have almost the same colour. No difference could be detected with the naked eye.

Measurement of the colour in transmitted light is not possible with the predetermined breaking position material from ample 3 since this material is pigmented black and is therefore opague.

### EXAMPLE 6

### Comparison of the Transmission Properties of the Predetermined Breaking Positioned and Polymeric Intermediate Layer

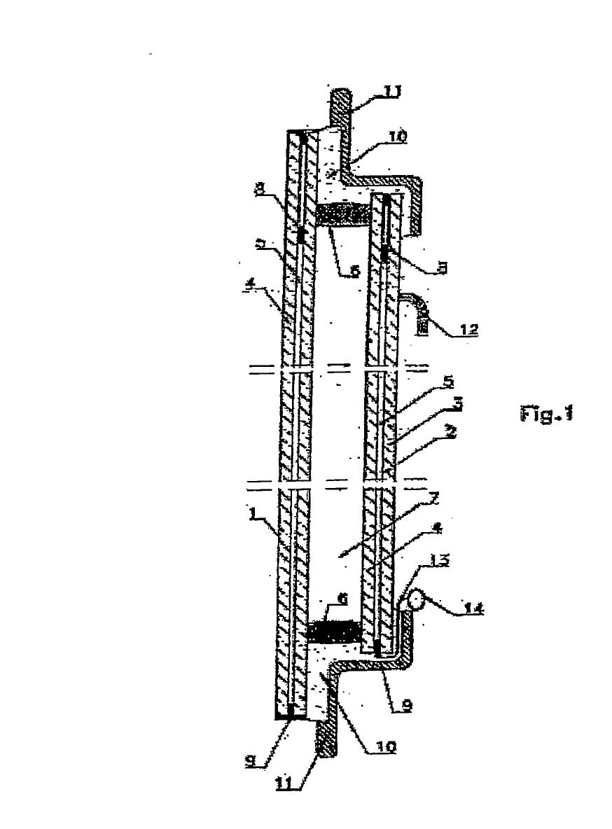

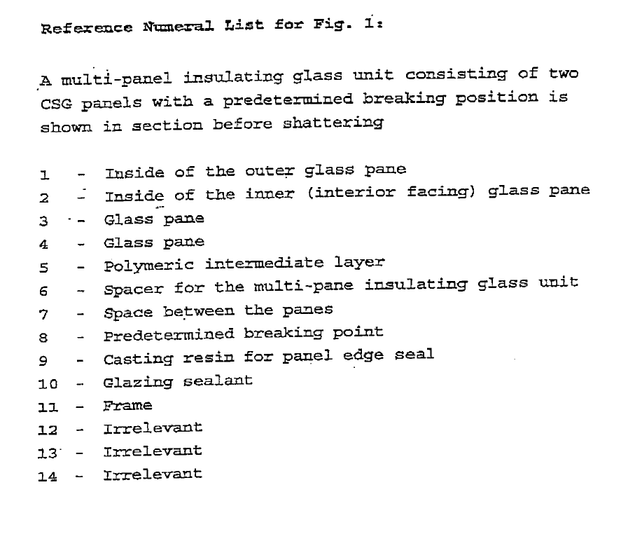

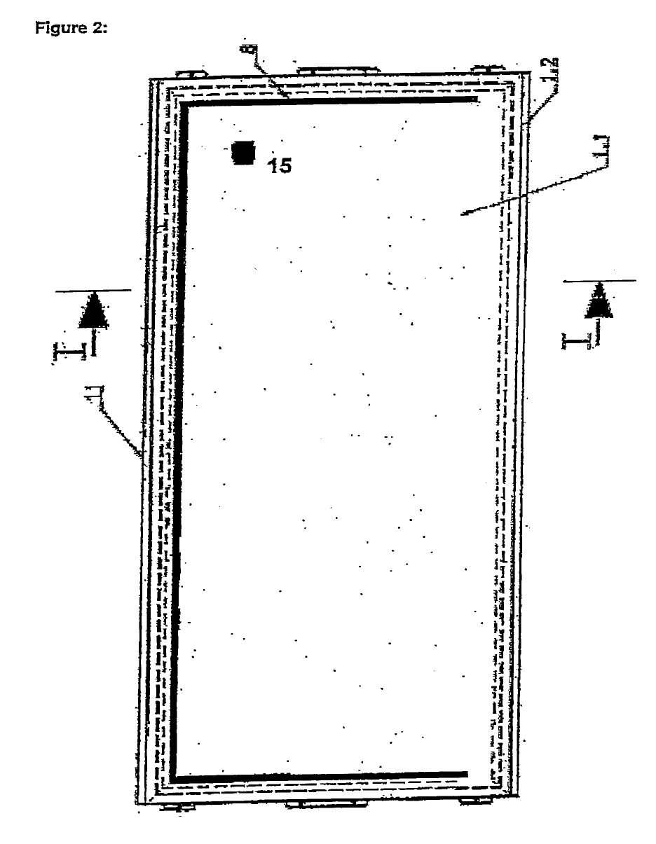

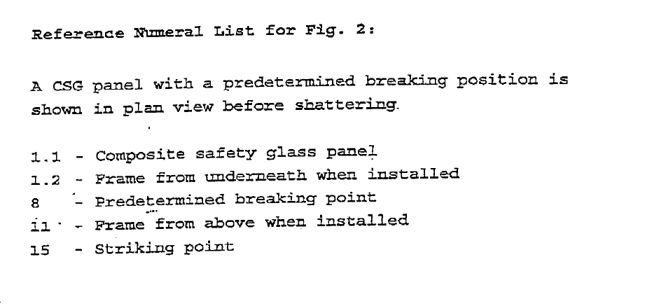

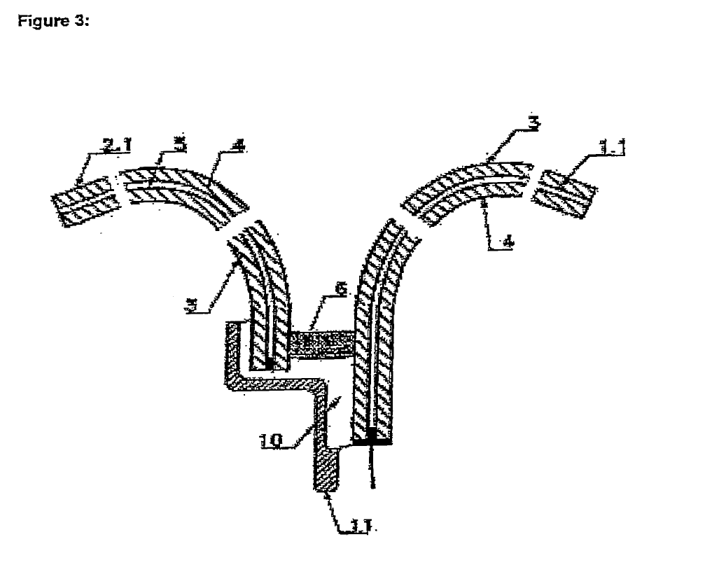

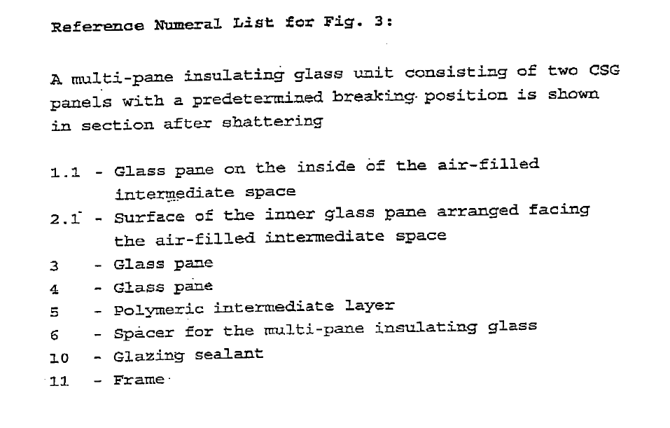

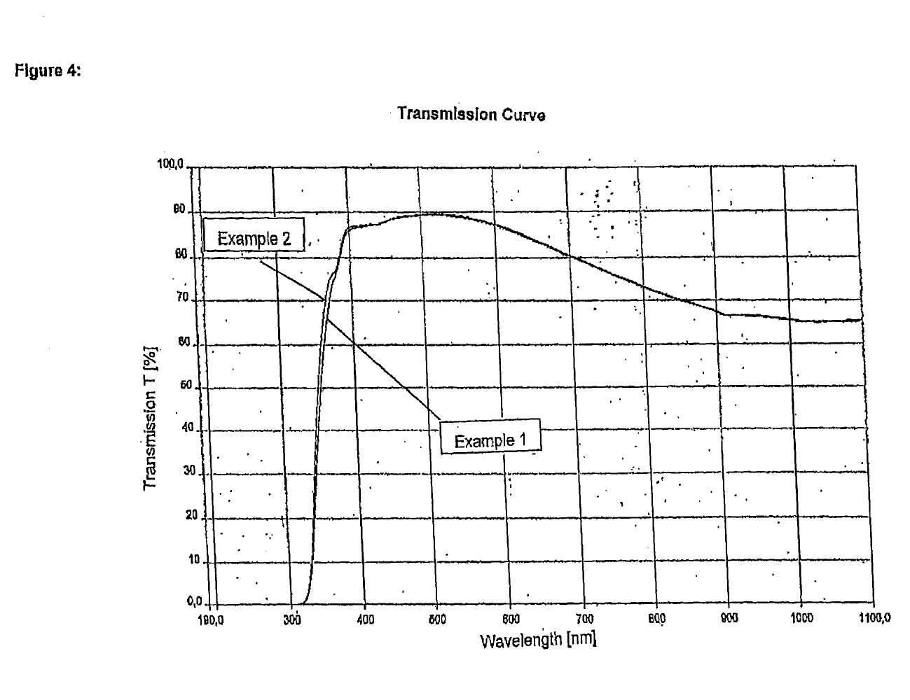

Transmission curves of the predetermined breaking position (from Example 1) and of the polymeric intermediate layer not forming the predetermined breaking position (from Example 2) were plotted. This was carried out in a similar mover to Example 5. A Comparison of the curves is shown in FIG. 4.

It can be seen that both samples have a almost identical transmission behaviour. To the human eye a CSG panel produced with the casting resins from Examples 1 and 2 appeared on inspection to be colourless ad transparent.

1. Composite safety glass panel with a predetermined breaking point, containing at least two prestressed glass panes and a polymeric intermediate layer, characterised in that
the polymeric intermediate layer contains two plastics materials of different fracture resistance (according to DIN 53504, 03/85, measured on an S2 standard test piece at a test speed of 100 mm/minute at 23° C.), different elongation at break (according to DIN 53504, 03/85, measured en an S2 standard test piece at a test speed of 100 mm/minute at 23° C.) and different fracture propagation resistance (according to DIN 53356, 08/82, measured on a 2 mm thick polymer film at a tear rate of 400 mm/minute at 23° C.),
wherein the composite glass panel at the predetermined breaking position contains the plastics material having the lower fracture resistance, the lower elongation at break and the lower fracture Propagation resistance, and the composite glass panel in the region that does not constitute the predetermined breaking position contains the plastics material with the higher fracture resistance, the higher elongation at break and the higher fracture propagation resistance., and
the composite glass panel in the intermediate layer contains at least at one position (at the striking point) one or more bodies of a material whose hardness is greater than that of the glass that is used.

2. Composite safety glass panel with a predetermined breaking position according to claim 1, characterised in that flat glasses from the group consisting of, alkali-lime glasses, such as soda, lime glass or borosilicate glasses, are selected as glass panels.

3. Composite safety glass panel with a predetermined breaking position according to claim 1 or 2, characterised in that the Mohs' hardness of the hard body or bodies at the striking point is >6.

4. Composite safety glass panel with a predetermined breaking position according to claim 3, characterized in that the Mohs hardness of the hard body or bodies at the striking point is >7.

5. Composite safety glass panel with a predetermined breaking position according to one or more of claims 1 to 4, characterised in that the hard bodies consist of granules or spheres.

6. Composite safety glass panel with a predetermined breaking position according to one or more of claims 1 to 5, characterized in that the hard body or bodies at the striking point consist of silicon carbide and/or corundum.

7. Composite safety glass panel with a predetermined breaking position according to one or more of claims 1 to 6, characterised in that the hard bodies have a size that is, 0.1 to 0.3 mm less than the thickness of the plastics intermediate layer.

8. Composite safety glass panel with a predetermined breaking position according to one or more of claims 1 to 7, characterised in that the hard bodies are embedded in polyisobutylene.

9. Composite safety glass panel with a predetermined breaking position according to one or more of claims 1 to 8, characterised in that the plastics material of the predetermined breaking position has the following fracture mechanical properties: fracture resistance 0.01 to 2 MPa, elongation at break 10 to 450%, fracture propagation resistance, maximum 3 N/mm, Shore A hardness (measured according to DIN 53505 on 6 mm thick test bodies at 23° C.) 1 to 40.

10. Composite safety glass panel with a predetermined breaking position according to one or more of claims 1 to 9, characterised in that the plastics material of the polymeric intermediate layer not forming the predetermined breaking position has the following fracture mechanical properties: fracture resistance at least 4 MPa, elongation at break at least 200%, fracture propagation resistance at least 6 N/mm, Shore A hardness (measured according to DIN 53505 on 6 mm thick test bodies at 23° C.) 30 to 70.

11. Composite safety glass panel with a predetermined breaking position according to one or more of claims 1 to 10, characterised in that one of the plastics materials or the plastics material contain a casting resin and/or a polymeric film.

12. Composite safety glass panel with a predetermined breaking position according to one or more of claims 1 to 11, characterised in that the plastics material used to produce the predetermined breaking position is selected from the group consisting of polyurethanes, polyesters, polyepoxides, polysiloxanes or polyacrylates and/or the plastics material used to produce the polymeric intermediate layer that does not constitute the predetermined breaking position is selected from the group consisting of polyurethanes, polyesters, polyepoxides, polysiloxanes, polyacrylates, polyvinyl acetals or polyvinyl acetates.

13. Composite safety glass panel with a predetermined breaking position according to claim 12, characterised in that the plastics material used to produce the predetermined breaking position and/or the plastics material used to produce the polymeric intermediate layer that does not constitute the predetermined breaking point, is based on polyacrylate.

14. Composite safety glass panel with a predetermined breaking position according to one or more of claims 1 to 11, characterised in that the plastics material used to produce the predetermined breaking position contains or consists of a thermoplastic material that is permanently flexible at room temperature.

15. Composite safety glass panel with a predetermined breaking position according to claim 14, characterised in that the thermoplastic material that is permanently flexible at room temperature is formed from a non-crosslinked or partially crosslinked polymer based on homopolymers, copolymers or terpolymers of isobutylene or mixtures thereof, and/or copolymers of acrylates or methacrylates or mixtures thereof.

16. Process for the production of a composite safety glass panel with a predetermined breaking point, characterised in that
a) a film is produced from a casting resin for the predetermined breaking position and strips having the geometry of the subsequent predetermined breaking position are cut out from this film,
b) a thermally prestressed glass plate is. provided with an edge seal,
c) the predetermined breaking position strips produced under a) are placed on the glass plate,
d) one or more hard bodies that have a hardness greater than that of the glass are applied to the glass plate at one or more arbitrary points,
e) a second thermally prestressed glass plate is placed on this arrangement,
f) the resultant glass plate composite is compressed,
g) a casting resin that in the hardened state has a higher fracture resistance, a higher elongation at break and a higher fracture propagation resistance than the casting resin of the predetermined breaking position is poured into the remaining space between the glass plates and hardened.

17. Process for the production of a composite safety glass panel with a predetermined breaking point, characterised in that
a) a thermally prestressed glass plate is provided with an edge seal,
b) as predetermined breaking position a thermoplastic material that is permanently flexible at room temperature is laid on the glass plate at the places provided for this purpose,
c) one or more hard bodies that have a hardness greater than that of the glass are applied to the glass plate at one or more arbitrary places,
d) a second thermally prestressed glass plate is laid on this arrangement,
e) the resultant glass plate composite is compressed,
f) a casting resin that in the hardened state has a higher fracture resistance, a higher elongation at break and a higher fracture propagation resistance than the thermoplastic material of the predetermined breaking position that is permanently flexible at room temperature is poured into the remaining space between the glass plates and is hardened.

18. Use of a composite safety glass panel with a predetermined breaking position according to one of claims 1 to 15 in buildings, rail vehicles, road vehicles and marine vehicles.
